(19) United States
(12) Patent Application Publication
(10) Pub. No.: US 2024/0118401 A1
(43) Pub. Date: Apr. 11, 2024

(54) METHODS AND SYSTEMS FOR TRACKING ZERO-ANGLE OF A GALVANOMETER MIRROR

(71) Applicant: Innovusion, Inc., Sunnyvale, CA (US)

(72) Inventors: Gang Zhou, San Jose, CA (US); Junwei Bao, Los Altos, CA (US); Philip Andrew Wingard, Mission Viejo, CA (US)

(73) Assignee: Innovusion, Inc., Sunnyvale, CA (US)

(21) Appl. No.: 18/374,566

(22) Filed: Sep. 28, 2023

Related U.S. Application Data
(60) Provisional application No. 63/412,239, filed on Sep. 30, 2022.

(51) Int. Cl. G01S 7/497; G01S 7/481

(52) U.S. Cl. CPC G01S 7/497; G01S 7/4817

(57) ABSTRACT

A method for tracking zero-angle position shift of a moveable mirror used in a LiDAR system is provided. The method comprises obtaining a first dataset based on a first intensity map. The first intensity map is associated with internal reflection pulses of a frame scanned by the LiDAR system. The frame comprises a plurality of scan positions. The internal reflection pulses are formed by scattering or reflecting one or more transmission light pulses at positions internal to a housing of the LiDAR system. The first dataset is a calibration dataset comprising representative intensity values and corresponding positions in the frame. The method further comprises obtaining a second intensity map of another frame at a subsequent time and obtaining a second dataset based on the second intensity map. The method further comprises determining the zero-angle position shift of the moveable mirror based on the first dataset and the second dataset.

### CROSS-REFERENCE TO RELATED APPLICATIONS

This application claims priority to U.S. Provisional Patent Application Ser. No. 63/412,239, filed Sep. 30, 2022, entitled “Methods and Systems for Tracking Zero-Angle of a Galvanometer Mirror,” the content of which is hereby incorporated by reference in its entirety for all purposes.

### FIELD OF THE TECHNOLOGY

This disclosure relates generally to light transmission and detection and, more particularly, to tracking a zero-angle position shift of a moveable mirror used in a light detection and ranging (LiDAR) system.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

Some LiDAR systems use a galvanometer mirror to scan in one direction, e.g., the vertical direction, of the FOV. The galvanometer mirror oscillates about an axis between two end positions. A center position is located at the midpoint of the two end positions. The angular position at the midpoint is referred to as the zero-angle position of the galvanometer mirror. By oscillating between the two end positions, the galvanometer mirror scans the outgoing light to cover, e.g., a vertical range of the FOV.

Since the LiDAR system is mounted on or integrated to a vehicle, factors such as vibrations of the vehicle may cause a shift in the zero-angle position of the galvanometer mirror over time. This shift can result in a corresponding shift in the LiDAR view of the surrounding environment. Consequently, the vertical position of objects in the LiDAR view may be inaccurately measured. This can lead to errors in the further processing of the LiDAR point cloud data. Any inaccuracies in the LiDAR data may pose a risk to the safety of passengers onboard. Therefore, it is important to timely detect any changes in the zero-angle position of the galvanometer mirror and the resulting fault in the LiDAR system.

One way to track the shift in the galvanometer mirror is to examine the position of the galvanometer mirror during regular vehicle maintenance, and recalibrate the system by readjusting the position of the mirror to the correct position. However, it may take a long time between two maintenance checks. Any shifts that occur in the meantime may go undetected and pose a potential safety risk to the passengers onboard. In this disclosure, methods and systems for tracking changes in the zero-angle position of the galvanometer mirror and the LiDAR system in real-time are disclosed.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7 is a block diagram illustrating an exemplary arrangement of components in a steering mechanism of a LiDAR system according to one embodiment.

FIG. 8A illustrates a LiDAR view of a road scene when the zero-angle position of the galvanometer mirror in the LiDAR system is not shifted.

FIG. 8B illustrates a LiDAR view of a road scene when the zero-angle position of the galvanometer mirror in the LiDAR system has been shifted.

FIG. 9A illustrates a road scene from a lateral perspective when the zero-angle position of the galvanometer mirror in the LiDAR system is not shifted.

FIG. 9B illustrates a road scene from a lateral perspective when the zero-angle position of the galvanometer mirror in the LiDAR system has been shifted.

FIG. 10 illustrates a steering mechanism with an outgoing light pulse partially reflected by a window of the LiDAR system according to one embodiment.

FIG. 11 illustrates an internal return light pulse and an object-returned light pulse detected by a light detector according to one embodiment.

FIG. 12 illustrates a diagram for calculating the intensity of a pulse according to one embodiment.

FIG. 13 illustrates a two-dimensional scan pattern scanned by steering mechanism 1000 according to one embodiment.

FIG. 14 illustrates two datasets of scattered pulse intensity of a LiDAR system obtained at two different times according to one embodiment.

FIG. 15 illustrates a Sum of Squared Difference chart of a galvanometer mirror which zero-angle position has shifted according to one embodiment.

FIG. 16 is a flowchart illustrating a method for tracking zero-angle position shift of a moveable mirror used in a LiDAR system according to one embodiment.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

An advantage of the present invention is that the LiDAR system can detect changes in zero-angle position of galvanometer mirror in real-time. This ability allows for prompt identification and detection of changes in both the galvanometer mirror and LiDAR system. Since shifts in the galvanometer mirror may pose potential safety risks to passengers, the system's ability to detect such changes in real-time is important for ensuring passenger safety.

Embodiments of the present invention are described below. In various embodiments of the present invention, a method for tracking zero-angle position shift of a moveable mirror used in a LiDAR system is provided. The method comprises obtaining a first dataset based on a first intensity map. The first intensity map is associated with internal reflection pulses of a frame scanned by the LiDAR system. The frame comprises a plurality of scan positions. In addition, the internal reflection pulses are formed by scattering or reflecting one or more transmission light pulses at positions internal to a housing of the LiDAR system. Furthermore, the first dataset is a calibration dataset comprising representative intensity values and corresponding positions in the frame. The method further comprises obtaining a second intensity map of another frame at a subsequent time and obtaining a second dataset based on the second intensity map. The method further comprises determining the zero-angle position shift of the moveable mirror based on the first dataset and the second dataset.

In another embodiment, a LiDAR system for tracking zero-angle position shift of a moveable mirror of the LiDAR system is provided. The LiDAR system comprises one or more processors, a memory device, and processor-executable instructions stored in the memory device. The processor-executable instructions comprise instructions for obtaining a first dataset based on a first intensity map. The first intensity map is associated with internal reflection pulses of a frame scanned by the LiDAR system. The frame comprises a plurality of scan positions. In addition, the internal reflection pulses are formed by scattering or reflecting one or more transmission light pulses at positions internal to a housing of the LiDAR system. Furthermore, the first dataset is a calibration dataset comprising representative intensity values and corresponding positions in the frame. The processor-executable instructions further comprise instructions for obtaining a second intensity map of another frame at a subsequent time and obtaining a second dataset based on the second intensity map. The processor-executable instructions further comprise instructions for determining the zero-angle position shift of the moveable mirror based on the first dataset and the second dataset.

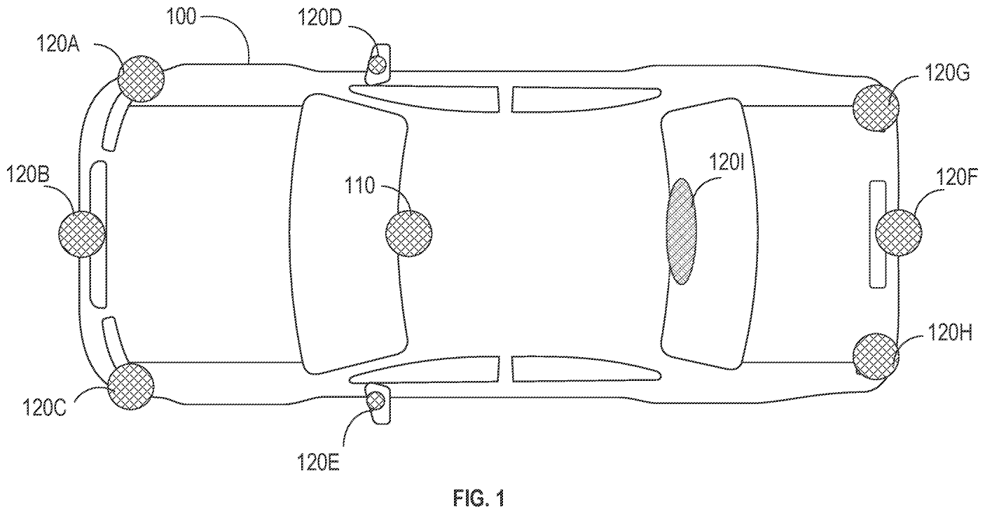

FIG. 1 illustrates one or more example LiDAR systems 110 and 120A-120I disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but have no steering mechanisms. System 110 may distribute transmission light to each of systems 120A-120I The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

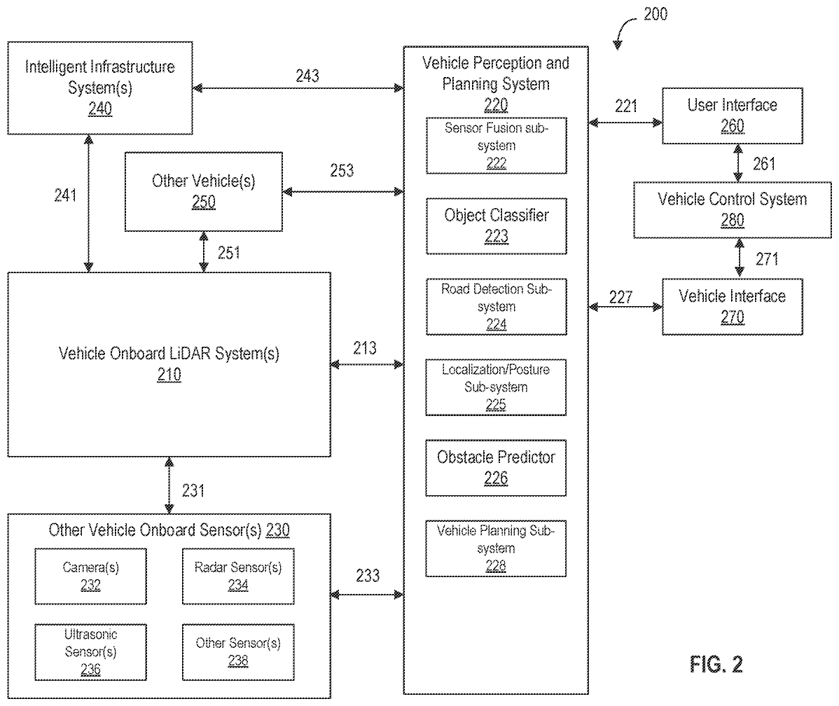

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitates producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any locations (e.g., rear-view mirrors, pillars, front grille, and/or back bumpers, etc.).

Other vehicle onboard sensos(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any locations (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 227 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

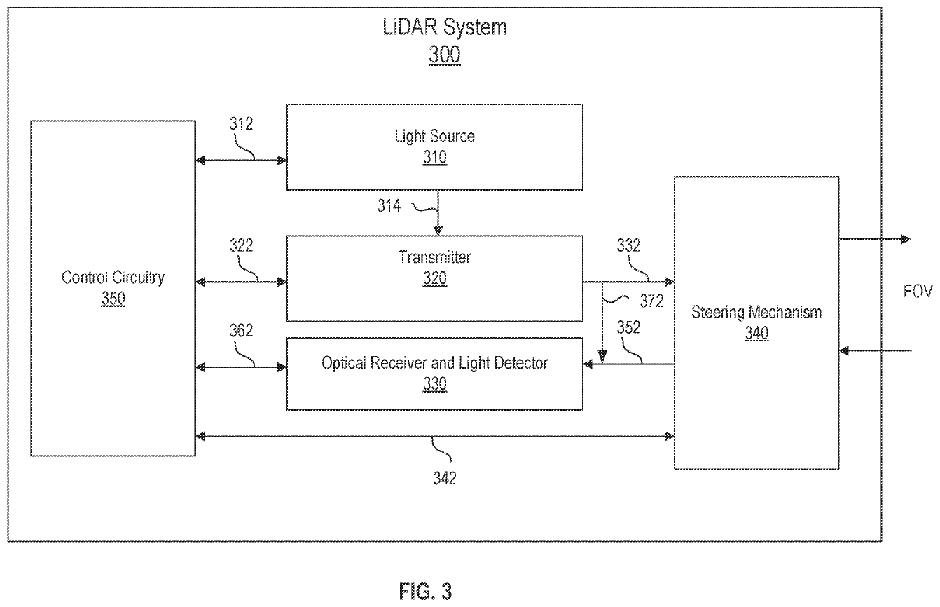

FIG. 3 is a block diagram illustrating an example LiDAR system 300. LiDAR system 300 can be used to implement LiDAR systems 110, 120A-120I and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. Route 372 may include one or more optics (e.g., optical fibers, lens, mirrors, etc.) for providing the light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

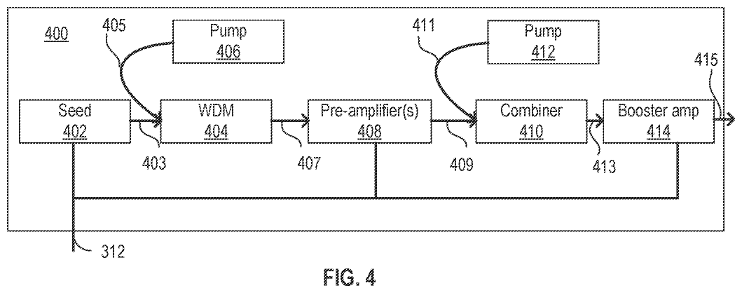

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 415. The booster amplifier 414 provides further amplification of the optical signals (e.g., another 20-40 dB). The output light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and /or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

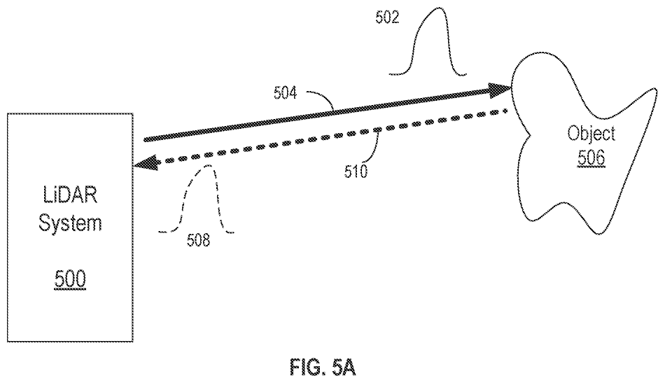

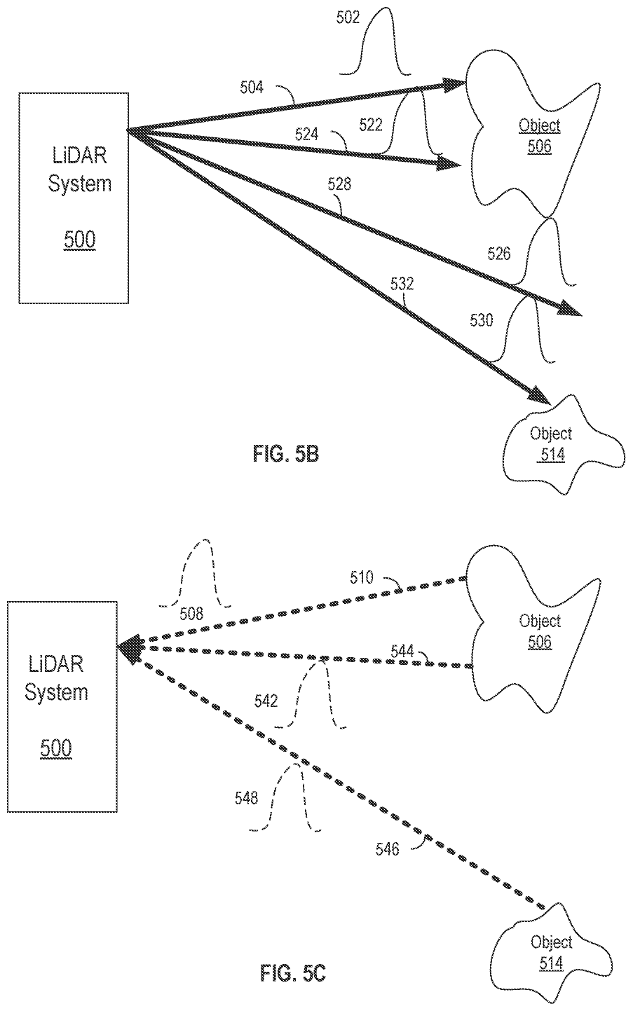

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

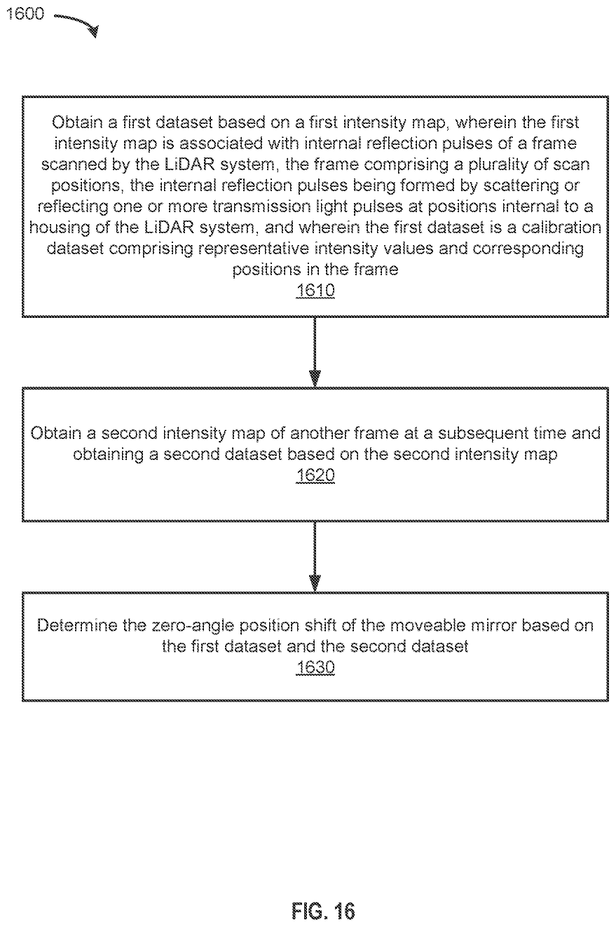

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps in FIG. 16, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

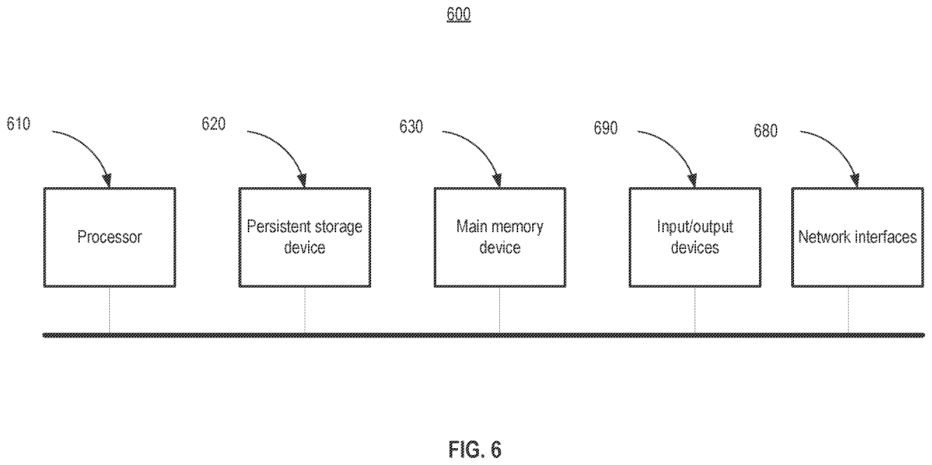

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of FIG. 16 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with FIG. 16. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

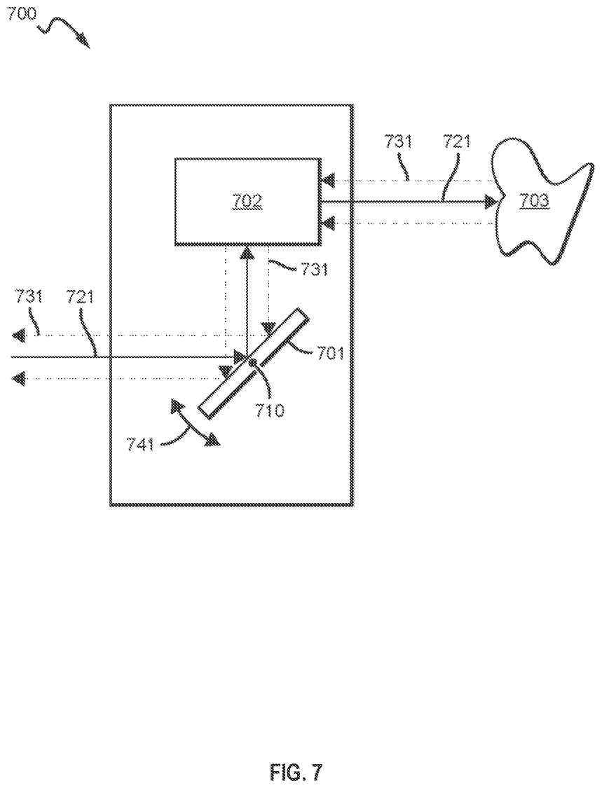

FIG. 7 is a block diagram illustrating an exemplary arrangement of components in a steering mechanism 700 of a LiDAR system according to one embodiment. Steering mechanism 700, which can be similar to steering mechanism 340 illustrated in FIG. 3, directs light beams from transmitter 320 to scan an FOV in multiple dimensions (e.g., in horizontal and vertical dimensions). Steering mechanism 700 includes a first mirror 701 and a second mirror 702. First mirror 701 scans in the vertical direction of the FOV, and second mirror 702 scans in the horizontal direction of the FOV. In other embodiments, first mirror 701 may scan in the horizontal direction and second mirror 702 may scan in the vertical direction of the FOV. First mirror 701 can be a galvanometer mirror or an oscillating mirror. First mirror 701 can have single or multiple planes. Second mirror 702 can be a polygon mirror, an oscillating mirror, a galvanometer mirror, a rotating prism, a rotating tilt mirror surface, or a single-plane or multi-plane mirror, etc. Second mirror 702 may include multiple aforementioned mirrors or a combination thereof.

As illustrated in FIG. 3, transmitter 320 receives laser light from light source 310 and transmits the laser light to steering mechanism 340 via communication path 332. In some embodiments, transmitter 320 and steering mechanism 340 may be combined or integrated as one component. In FIG. 7, the laser light coming from transmitter 320 via communication path 332 is depicted as outgoing light pulse 721. In steering mechanism 700, outgoing light pulse 721 is first directed to first mirror 701, then reflected by first mirror 701 to second mirror 702, and then directed by second mirror 702 to illuminate object 703 in the FOV. In other embodiments of a steering mechanism, the positions of first mirror 701 and second mirror 702 may be switched. Second mirror 702 may be a galvanometer mirror or an oscillating mirror, and first mirror 701 may be a polygon mirror, an oscillating mirror, a galvanometer mirror, a rotating prism, rotating tilt mirror surface, single-plane or multi-plane mirror, etc., or a combination thereof.

First mirror 701 (also “galvanometer mirror 701” or “mirror 701” hereinafter) is controlled to oscillate about axis 710. The oscillation of galvanometer mirror 701 facilitates the scanning of light pulses along one dimension (e.g., the vertical dimension) of an FOV. Galvanometer mirror 701 reflects outgoing light pulse 721 and directs the same toward second mirror 702. Through the movement of second mirror 702, e.g., rotating or oscillating, second mirror 702 scans outgoing light pulse 721 along a second dimension of the FOV. For example, if galvanometer mirror 701 scans in the vertical dimension of the FOV, second mirror 702 may scan in the horizontal dimension of the FOV, or vice versa. Second mirror 702 then directs outgoing light pulse 721 to illuminate one or more objects (e.g., object 703) in the FOV.

First mirror 701 and second mirror 702 are used for both transmitting light pulses to illuminate objects in an FOV and for receiving and redirecting return light to optical receiver and light detector 330. When outgoing light pulse 721 travels to illuminate object 703 in the FOV, at least a portion of the light pulse is reflected or scattered by object 703 to form return light 731. Return light pulses may be collected substantially coaxial with or parallel to the outgoing light pulses. Return light 731 is received by second mirror 702 and is redirected (e.g., reflected) by second mirror 702 toward galvanometer mirror 701. Return light 731 is then redirected (e.g., reflected) by galvanometer mirror 701 to optical receiver and light detector 330 via communication path 352 (shown in FIG. 3).

Galvanometer mirror 701 can be controlled by, e.g., actuators or motors, to oscillate about axis 710. Mirror 701 oscillates back and forth between two end positions. Arrows 741 depict the directions of the oscillatory motion of mirror 701. As mirror 701 oscillates, its angular position can be used to describe its position at any given moment. Between the two end positions, mirror 701 oscillates back and forth around a center position, which is located at the midpoint of the two end positions. This angular position at the midpoint is referred to as zero degree, zero position, or zero-angle position, of the galvanometer mirror 701. In one embodiment, by oscillating between the two end positions, mirror 701 scans the outgoing light to cover a vertical range of the FOV, which can be about or greater than 25 degrees, e.g., about 30 degrees, 50 degrees, or 75 degrees, etc.

There is a direct relationship between the angular range of galvanometer mirror 701 and the vertical range of the FOV, which is also expressed in angular format. The greater the angular range of the oscillatory motion of mirror 701, the wider the vertical range of the FOV that can be scanned by the LiDAR system. However, it is to be noted that the two angular ranges may or may not be the same. In some embodiments, the two angular ranges are the same. For example, the angular ranges of the galvanometer mirror and the vertical range of the FOV can both be from −15° to −15°. In other embodiments, the two angular ranges are different. For example, a galvanometer mirror's angular range can be from −5° to +5°, while the vertical range of the FOV may range from −15° to +15°. Nevertheless, the angular position of 0° for the galvanometer mirror aligns with the vertical center position of the FOV.

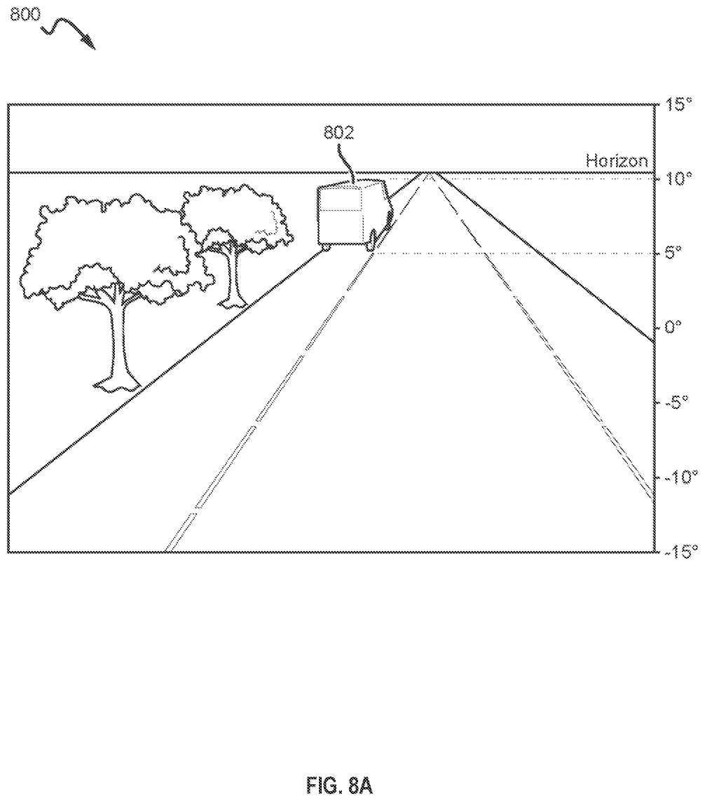

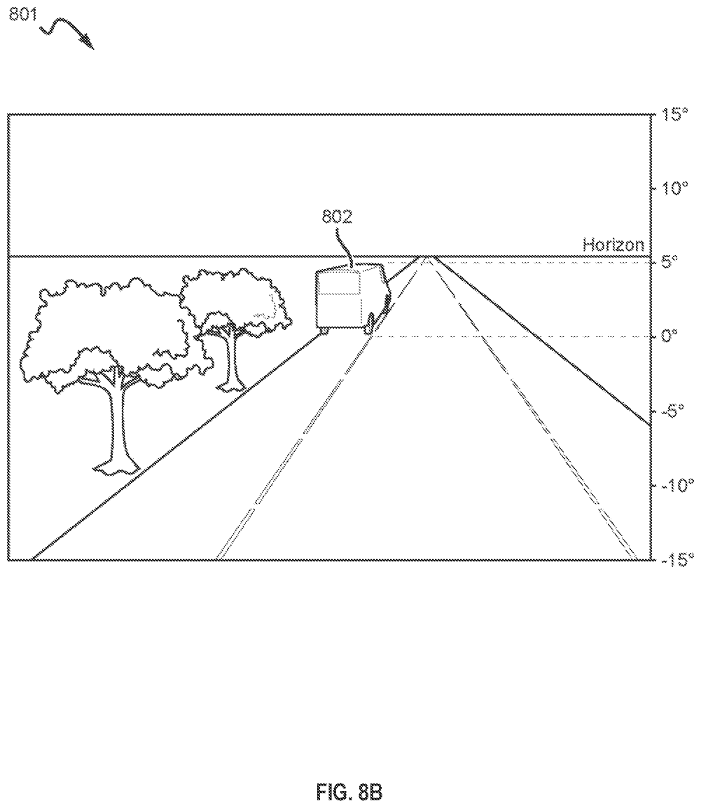

Normally, when a LiDAR system is installed on a vehicle, the zero-angle position of the galvanometer mirror is calibrated to align with the vertical center of the FOV of the LiDAR system. FIG. 8A illustrates LiDAR view 800 of a road scene when the zero-angle position of the galvanometer mirror in the LiDAR system is not shifted. LiDAR view 800 is a 3D point cloud view of the external environment perceived by the LiDAR system. To obtain such a view, the LiDAR system can be mounted on the vehicle's rooftop. In other embodiments, the LiDAR system can be mounted on, or integrated to, a vehicle at other locations (e.g., rear-view mirrors, pillars, front grille, and/or back bumpers, etc.). The angles displayed on the right-hand side of LiDAR view 800 represent the vertical angles of the FOV, spanning from −15° to 15°. This indicates that the FOV has a 30-degree vertical range.

Each vertical angle in LiDAR view 800 can be mapped to an angular position of galvanometer mirror 701 as it oscillates between its two end positions. One end of the two end positions of mirror 701 corresponds to the 15° vertical angle in LiDAR view 800, which is the upper boundary of the FOV's vertical range. The other end of the two end positions of mirror 701 corresponds to the −15° vertical angle in LiDAR view 800, which is the lower boundary of the FOV's vertical range. The zero position of the galvanometer mirror corresponds to the 0° angle in LiDAR view 800, which is located at the center of the vertical view. Each point in LiDAR view 800 corresponds to a specific vertical angle within the field of view. For example, the points representing vehicle 802 correspond to a vertical range of 5° to 10° within the FOV.

As the zero-angle position of galvanometer mirror 701 corresponds to the vertical location of 0° angle in LiDAR view 800, a shift in mirror 701's zero-angle position can cause the 0° angle location of LiDAR view 800 to be shifted up or down. In FIG. 8A, the zero position of the galvanometer mirror is not shifted. The shift of galvanometer mirror's zero position may occur when there is a change in the mirror's position relative to the vehicle. As the LiDAR system is mounted on a vehicle, shocks or vibrations of the vehicle over time may result in position changes of components within the LiDAR system, or position changes of the LiDAR system itself relative to the body of the vehicle. When the galvanometer mirror's relative position within the LiDAR system's housing changes slightly, the zero position of the galvanometer mirror may be shifted. Other factors may also cause the shift, e.g., faults in the actuator or motor driving the movement of the galvanometer mirror, faults in the galvanometer mirror itself or any mechanical parts, or dust, dirt or moisture accumulated in the LiDAR system housing, etc. When galvanometer mirror's zero-angle position is shifted, the corresponding LiDAR view of the external environment is also shifted.

FIG. 8B illustrates LiDAR view 801 of a road scene when the zero-angle position of the galvanometer mirror in the LiDAR system has been shifted. In the illustration of FIG. 8B, the external environment is exactly the same as the external environment of FIG. 8A. No elements in the external environment in FIG. 8A have moved in FIG. 8B. In FIG. 8B, the zero-angle position of the galvanometer mirror of the LiDAR system has been shifted. This shift causes the 0° angle location of LiDAR view 801 to be shifted up by, e.g., 5 degrees, with respect to the external environment. In other embodiments, a shift in zero-angle position of the galvanometer mirror may cause the 0° angle location of LiDAR view 801 to be shifted down. Comparing FIG. 8B with FIG. 8A, LiDAR view 801 displays less of the road immediately ahead and more of the sky above the horizon than LiDAR view 800, while other objects (the road, the trees, and vehicle 802) stay the same. Conceptually, LiDAR view 801 can be visualized as a camera tilted upwards, or if the camera is fixed, the road (along with the horizon and the sky) is tilted downwards. Because of the shift, the data points representing vehicle 802 now correspond to 0° to 5° degrees in LiDAR view 801, instead of between 5° to 10° as in LiDAR view 800. As a result, because of the shift in zero-angle position of the galvanometer mirror, the angular information of vehicle 802 is incorrectly obtained. This can cause errors in the further processing of the LiDAR data.

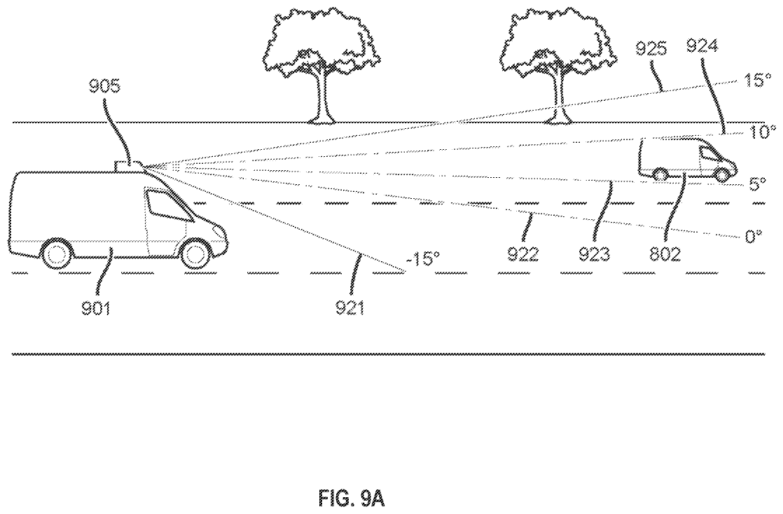

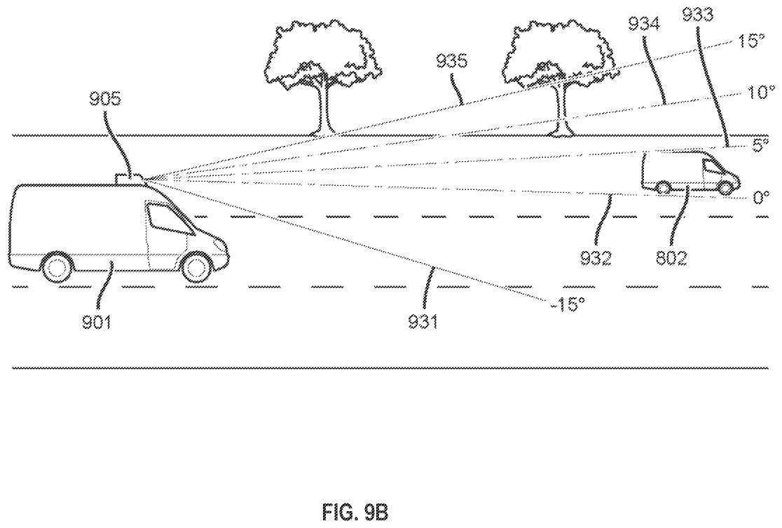

FIGS. 9A and 9B illustrate a lateral perspective of the same road scenes as in FIGS. 8A and 8B, respectively. FIG. 9A illustrates a road scene from a lateral perspective when the zero-angle position of the galvanometer mirror in the LiDAR system 905 is not shifted. LiDAR system 905 is mounted on top of vehicle 901. The vertical range of LiDAR system 905's FOV is from −15° to −15°. Line 921 represents the lower boundary of the vertical range)(−15°). Line 925 represents the upper boundary of the vertical range)(15°. The 0° position of LiDAR system 905's FOV, which corresponds to the zero-angle position of the galvanometer mirror, is represented by line 922. Same as in FIG. 8A, vehicle 802's vertical range is between 5° (line 923) to 10° (line 924) within the FOV.

FIG. 9B illustrates a road scene from a lateral perspective when the zero-angle position of the galvanometer mirror in the LiDAR system has been shifted. Same as in FIG. 9A, LiDAR system 905 is mounted on top of vehicle 901. The external environment of FIG. 9B is exactly the same as the external environment of FIG. 9A. No elements in FIG. 9A have moved in FIG. 9B. In FIG. 9B, the zero-angle position of the galvanometer mirror in LiDAR system 905 has been shifted. In FIG. 9B, the vertical range of LiDAR system 905's FOV is still from −15° to −15° (between lines 931 and 935). However, the 0° position of LiDAR system 905's FOV (represented by line 932) has been shifted upwards (comparing to FIG. 9A). Therefore, in FIG. 9B, vehicle 802's vertical range is now between 0° (line 932) to 5° (line 933) within the FOV, instead of between 5° to 10° as in FIG. 9A. Again, because of the shift in zero-angle position of the galvanometer mirror, the angle information of vehicle 802 is incorrectly obtained. Incorrect angular positions of objects in the FOV may affect the precision of positioning and/or distancing of the objects, which may in turn cause errors in further processing of the LiDAR point cloud data (e.g., wrong sensor fusion/perception/measuring/planning etc.).

A deviation in the galvanometer mirror's zero-angle position can result in inaccurate distance and object position measurements within the FOV and may jeopardize the vehicle's safe operation. The techniques discussed herein illustrate systems and methods for tracking the galvanometer mirror's zero-angle position and deviation. In some embodiments, the tracking of the zero-angle position and deviation is based on internal reflection in the LiDAR system.

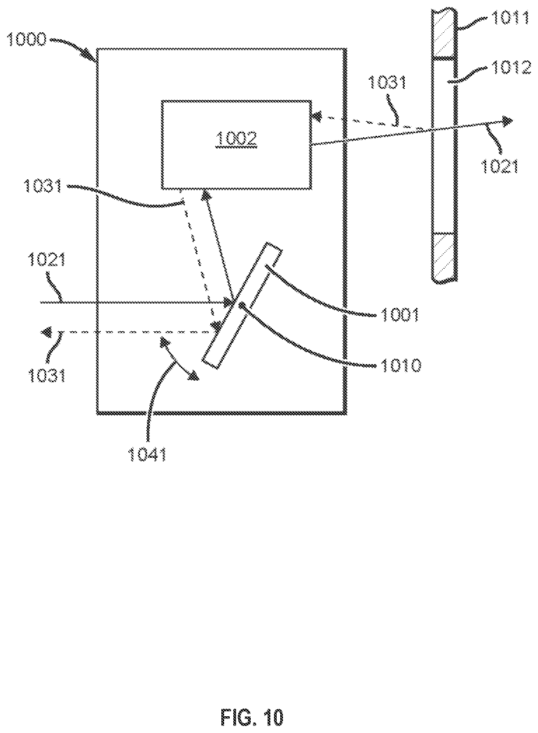

Before an outgoing light pulse leaves the LiDAR system, a small portion of the light energy may be reflected back into the LiDAR system by the LiDAR system itself. FIG. 10 illustrates a steering mechanism 1000 with an outgoing light pulse partially reflected by a window of the LiDAR system according to one embodiment. Steering mechanism 1000 is similar to steering mechanism 700 illustrated in FIG. 7 or steering mechanism 340 illustrated in FIG. 3. Steering mechanism 1000 includes a first mirror 1001 and a second mirror 1002, which are similar to first mirror 701 and second mirror 702 in FIG. 7, respectively. First mirror 1001 (also referred to as galvanometer mirror 1001 and are used interchangeably) oscillates about axis 1010 between two end positions. Arrows 1041 depict the directions of the oscillatory motion of mirror 1001. FIG. 10 also depicts a segment of wall 1011 of the LiDAR system housing, which encloses steering mechanism 1000. Wall 1011 comprises a window 1012, through which the outgoing and return lights traverse.

Outgoing light pulse 1021 is generated by transmitter 320 and is transmitted via communication path 332 of FIG. 3 to steering mechanism 1000. In steering mechanism 1000, outgoing light pulse 1021 is first directed to first mirror 1001, then reflected by first mirror 1001 to second mirror 1002, and then directed by second mirror 1002 toward window 1012. Some windows may exhibit partial reflectivity due to their material composition and/or surface properties. Consequently, a window may scatter or reflect back a small fraction of an incident light, while allowing most of the incident light to pass through. When light pulse 1021 passes through window 1012, a small portion of light pulse 1021 is reflected back as scattered light pulse 1031 toward the inside of the LiDAR system housing. Scattered light pulse 1031 (also referred to as internal return light pulse, internal reflection pulse, scattered pulse, or internally scattered pulse, and are used interchangeably herein) may reach mirror 1002 directly as illustrated in FIG. 10. It is then redirected by mirrors 1002 and 1001 to optical receiver and light detector 330 of FIG. 3 (hereinafter, “light detector 330”).

In other embodiments, one or more lenses may be located in-between steering mechanism 1000 and window 1012 (not shown in the figure). Lenses may also be located elsewhere in the LiDAR system housing, e.g., between light detector 330 and steering mechanism 1000 (not shown in the figure). Similar to windows, lenses may exhibit partial reflectivity due to their material composition and/or surface properties and may scatter or reflect back a small fraction of an incident light, while allowing most of the incident light to pass through. Scattered light pulses may be formed and reflected back by one or more of these lenses.

Due to various designs of LiDAR housing and internal components, the relative positions between window 1012 and mirror 1002 may vary. Consequently, sometimes scattered light pulse 1031 may not be reflected directly from window 1012 to mirror 1002, but may be first reflected to other sections of the LiDAR housing, or other components inside or outside of the LiDAR system housing, such as lenses, glasses, or surface of various components that are reflective. Sometimes, scattered light pulses may be formed and reflected by these other components of the LiDAR system without reaching the windows of LiDAR system housing. Scattered light pulses may also be reflected back and forth several times by these various components, walls and/or windows.

Regardless of how scattered light pulses may be formed and reflected inside the LiDAR system housing, it may still eventually reach mirror 1002 and be directed to mirror 1001 and to light detector 330 of FIG. 3. In some cases, scattered light pulse 1031 may, after being formed and reflected inside the LiDAR housing, reach mirror 1001 directly (thereby skipping mirror 1002) and may eventually reach light detector 330. In some cases, scattered light pulse 1031 may, after being formed and reflected inside the LiDAR housing, reach light detector 330 directly (thereby skipping both mirrors 1001 and 1002). In the embodiment mentioned above (where lenses located in-between light detector 330 and steering mechanism 1000), scattered light pulses may be formed and reflected by those lenses before the outgoing light pulse reaches steering mechanism 1000. Sometimes, one outgoing light pulse may be scattered by several components in the LiDAR housing, e.g., lenses, windows, surface of components, etc., and form several scattered light pulses. Since the distances between these components are small, the timing differences of these separately formed scattered light pulses are negligible. Therefore, regardless of how the one or more scattered light pulses may eventually reach light detector 330, they merge together and may be detected by light detector 330 as a single scatter return pulse.

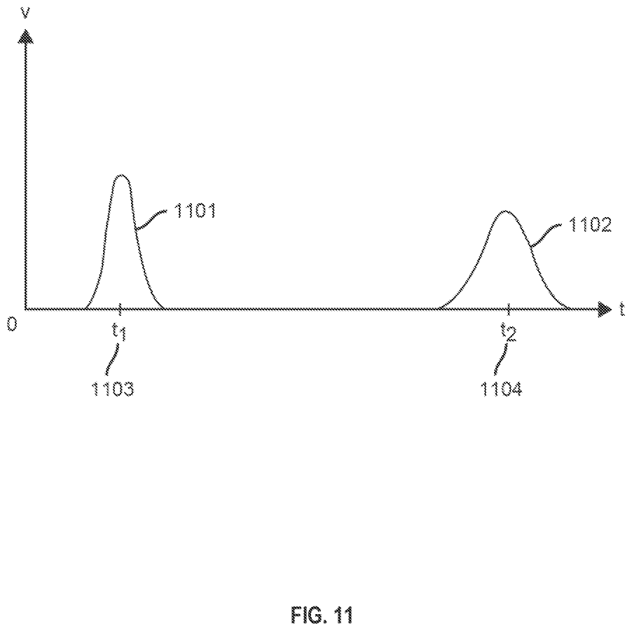

FIG. 11 illustrates an internal return light pulse and an object-returned light pulse detected by light detector 330 according to one embodiment. Both light pulses originate from the same outgoing light pulse 1021 in FIG. 10. When the outgoing light pulse reaches window 1021, internal return light pulse 1031 is formed and reflected by window 1021, and is detected by light detector 330 as waveform 1101. The remaining portion of outgoing light pulse 1021 continues to traverse through window 1021 and hits an object (e.g., object 703 in FIG. 7) in the FOV. An object-returned light pulse (e.g., return light pulse 731 of FIG. 7) is formed and is detected by light detector 330 as waveform 1102.

In FIG. 11, the t-axis (horizontal axis) is the time axis representing the lapse of time. The origin of the t-axis is the start time when laser source 310 generates outgoing light pulse 1021 or a time of a reference signal originated from laser source 310 is emitted. The v-axis represents the voltage amplitude of the waveforms. Time 1103 (t₁) represents the timing of internal reflection pulse 1101. Time 1104 (t₂) represents the timing of object-returned light pulse 1102. Because window 1012, or other lenses or components in the LiDAR system housing which may form the internal reflection pulse 1101, are always closer to light detector 330 than any physical object in the FOV, t₁ is always earlier than t₂.

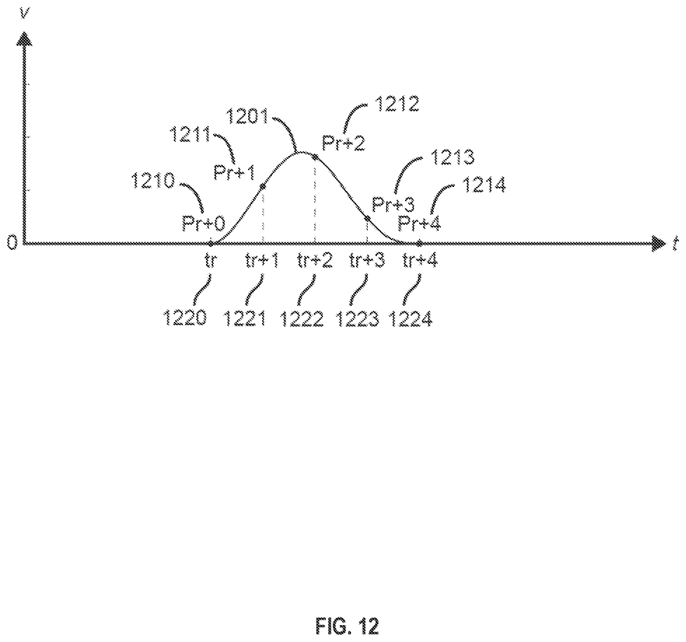

FIG. 12 illustrates a diagram for calculating the intensity of a pulse according to one embodiment. Waveform 1201 is the waveform of scattered light pulse 1031. The t-axis (horizontal axis) is the time axis representing the lapse of time. The origin of the t-axis is the start time when light source 310 generates an outgoing light pulse. The v-axis (vertical axis) represents the voltage amplitude of the waveform. Analog waveform 1201 is sampled by an analog-to-digital converter at a sampling rate of, e.g., 1 GHz , and is sampled at times 1220 (tᵣ), 1221 (tᵣ₊₁), 1222 (tᵣ₊₂), 1223 (tᵣ₊₃), and 1224 (tᵣ₊₄). The corresponding voltage amplitudes of return light pulse 1201 at each sampled time are amplitudes 1210 (Pᵣ₊₀), 1211 (Pᵣ₊₁), 1212 (Pᵣ₊₂), 1213 (Pᵣ₊₃), and 1214 (Pᵣ₊₄), respectively. The series of the sampled digital values of 1210-1214 (imagining connecting 1210-1214 with line segments) may sufficiently represent the shape of the analog waveform 1201. It should be understood that while FIG. 12 uses 1 GHz sampling rate as an example, other sampling rates are also possible.

The intensity of a pulse is the sum of the sampled amplitude value of the waveform at each sampled position. For example, the intensity of pulse 1201 can be calculated using the following formula (1):

$$Intensity = {\sum }_{i = 0}^{n} {P}_{r + i} \qquad ( 1 )$$

In the above formula (1), r+i represents each sampled position, Pᵣ₊ᵢ represents the amplitude of the waveform at sampled position r+i, and n represents the last sampled position of the waveform. In FIG. 12, n is 4, representing that the last sampled position of internal return light pulse 1201 is r+4 (position 1224) and the amplitude of that sampled position is Pᵣ₊₄ (amplitude 1214). Using formula (1), the intensity of pulse 1201 in FIG. 12 can be calculated as the sum of Pᵣ₊₁+Pᵣ₊₂+Pᵣ₊₃ (since the value of Pᵣ₊₀ and Pᵣ₊₄ is zero or negligible).

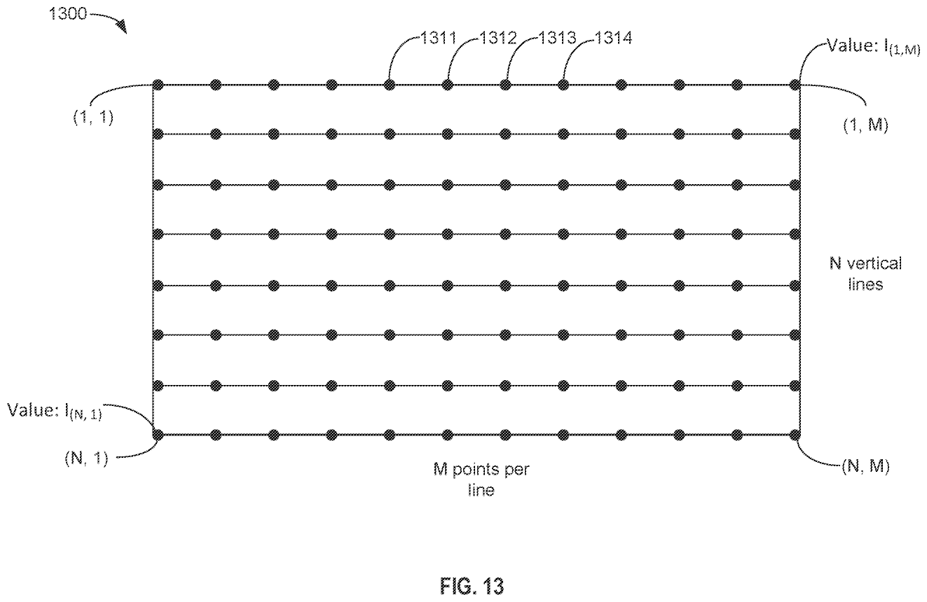

Referring back to FIGS. 10 and 11, waveform 1101 represents an internal return light pulse corresponding to outgoing light pulse 1021, which is transmitted when mirrors 1001 and 1002 are at a specific pair of rotational and/or oscillatory positions. This pair of physical positions of the two mirrors corresponds to a two-dimensional point in the FOV. FIG. 13 illustrates a two-dimensional scan pattern scanned by steering mechanism 1000 according to one embodiment. An entire FOV is scanned by completing one full cycle of the scan pattern. Each full scan cycle of the FOV produces a frame, denoted as frame 1300. Frame 1300 has N horizontal scan lines. Each horizontal scan line has M scan positions (points). It should be understood that the number of scan lines and points in each scan line depicted in FIG. 13 are for illustration purposes only. In reality, the actual numbers of M and N can be much greater than what are shown in the figure. Each point in frame 1300 corresponds to a coordinate in the FOV. For example, the coordinate of the top left point is (1,1), and the coordinate of the bottom right point is (N, M), etc. In one embodiment, second mirror 1002 performs the scan horizontally. After one horizontal line is scanned, first mirror 1001 moves to the next vertical position, and the next horizontal line is scanned. Accordingly, each point in frame 1300 also corresponds to a particular pair of movement positions of mirrors 1001 and 1002. Upon mirror 1001's completion of one full cycle of oscillation from one end to the other, the LiDAR system achieves a full scan of one frame.

During the scanning of each horizontal line, M outgoing light pulses are being transmitted. To scan frame 1300, a total of M×N outgoing pulses are being transmitted. As explained previously, each of the M×N outgoing light pulses can cause a scattered pulse to be formed and detected. Thus, a total of M×N scattered pulses can be formed and detected by light detector 330. Accordingly, each point in frame 1300 not only represents the outgoing pulse scanned in that particular position, but also the scattered pulse detected in that particular position. In addition, frame 1300 also represents an intensity map. Each point in frame 1300 has a value, which represents the intensity of the scattered pulse of that position. For example, the value of point (1, M) is depicted as I_{(1, M)}, and the value of point (N,1) is depicted as I_{(N,1)}.

Each point in frame 1300 has a one-to-one mapping to a specific pair of movement positions of mirrors 1001 and 1002. As previously explained, internally scattered pulses are formed and reflected by lenses, windows, glasses, and/or other various components in the LiDAR system housing. Since most of these components do not move, the manner in which they form and reflect a particular scattered pulse should be substantially the same every time mirrors 1001 and 1002 move to that particular pair of physical positions. Therefore, the intensity of each scattered pulse of a specific position within a frame should stay substantially the same across all frames, if the frames are scanned within a relatively short period of time. Over an extended period of time, the scattered pulse intensity of some positions in a frame may change. This is partly because the relative positions of components in the housing may change due to external forces, such as wind or rain, or shocks or vibrations of the vehicle. The surface of some elements (e.g., walls, windows) may deform over time. In addition, the reflectivity of components may also change in the long run due to wear and tear, or the accumulation of dust and dirt, among other factors.

The values of points in frame 1300 may be arranged in series to constitute a dataset. This dataset may exhibit patterns unique to each individual LiDAR system. The patterns are stable and unique signatures to each individual LiDAR system for at least the two following reasons. First, there are deviations when the components of LiDAR systems are manufactured. For example, one piece of window being manufactured on a production line may not be exactly the same in all aspects (e.g., in thickness, reflectivity, color, etc.) as the next piece of window being manufactured on the same production line. This can cause deviations reflectivity in each manufactured component. Second, when different components of a LiDAR system are assembled to produce the final product, there are deviations in relative positions of the components in the LiDAR system housing. For example, in one LiDAR system that comes out of an assembly line, a lens may be 0.1 millimeter closer to the window than the lens in the next LiDAR system being assembled. Although deviations in reflectivity and relative positions of LiDAR components do not affect the performance of a LiDAR system, they can affect the intensities of internally scattered pulses detected in a frame. Thus, the internally scattered pulse intensities of a frame of one LiDAR system are different from that of another LiDAR system.

The pattern of the dataset of scattered pulse intensities (also referred to as the “internal reflection pattern”) is unique to each LiDAR system and tends to remain constant within a short period of time. For these reasons, the datasets of the internal reflection pattern of a LiDAR system, if obtained and compared at different times, may reveal whether the zero-angle position of the galvanometer mirror of that LiDAR system has shifted, and if so, the degree of the shift.

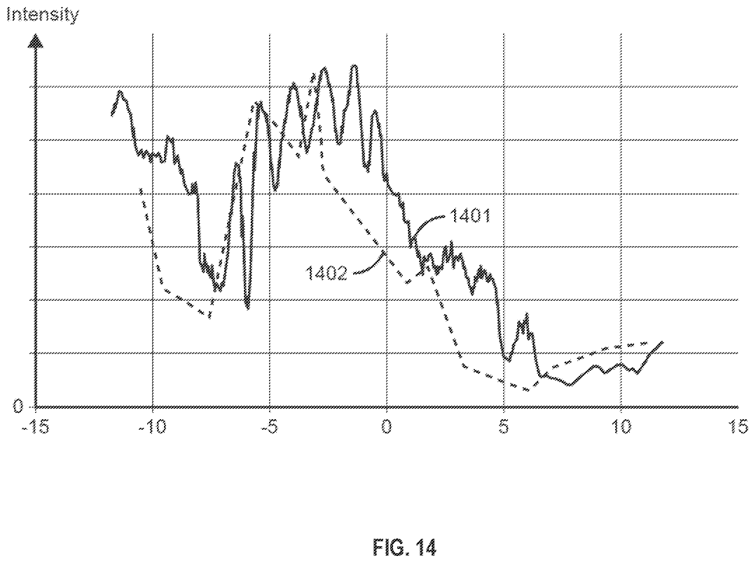

FIG. 14 illustrates two datasets of scattered pulse intensity of a LiDAR system obtained at two different times according to one embodiment. The horizontal coordinate represents a vertical range from −15° to 15° of an FOV, which is the entire range of the galvanometer mirror. The horizontal axis contains N points, where each point corresponds to a horizontal scan line n (ranging from 1 to N) in frame 1300. As explained previously, each point on the horizontal axis also corresponds to an angular position of the galvanometer mirror. The vertical coordinate represents the average intensity of scattered pulses of the corresponding horizontal scan line n. Referring back to FIG. 13, the average scattered pulse intensity of each scan line n can be calculated using the following formula (2):

$$Average intensity of line n = \frac{1}{M} {\sum }_{m = 1}^{M} l ( n , m ) \qquad ( 2 )$$

where m is a variable ranging from 1 to M, n is a variable ranging from 1 to N, N represents the total number of scan lines in a frame, M represents the total number of points in each scan line n, and I(n, m) represents the intensity of the scattered pulse of each point at location (n, m). Referring still to FIG. 14, dataset 1401 is obtained based on the intensity map associated with frame 1300. Dataset 1401 comprises a set of N data points. Each data point of the dataset can be obtained by calculating the average intensity for each of the N scan lines using formula (2).

In other embodiments, each data point in dataset 1401 can be the average intensity of a group of selected points in the corresponding scan line. The number of selected points in the group can be in any number. The points can also be selected from any sections of the scan line. For example, referring again back to FIG. 13, in one embodiment, the average intensity of each scan line can be calculated based on the average intensity of four selected points (points 1311-1314 for line 1, and points in the same locations for other lines). In another embodiment, around 40 to 50 points may be selected around the center of the scan line to calculate average scattered pulse intensity. In other embodiments, each data point in dataset 1401 can be the intensity of any single point in the corresponding scan line. In yet another embodiment, each data point in dataset 1401 can be the mean, minimum, or peak value among all the M points in the corresponding scan line.

In yet other embodiments, multiple intensity maps associated with multiple frames (one of which is frame 1300) may be first obtained. A representative intensity map is then generated by calculating the average values of corresponding points in the multiple intensity maps. Subsequently, dataset 1401 can be obtained using similar methods described above based on the representative intensity map. In one embodiment, the multiple frames are consecutively ordered. In other embodiments, the multiple frames can be determined by fixed or random intervals.

In some embodiments, dataset 1401 is obtained when the LiDAR system's internal reflection pattern is being calibrated. The calibrated dataset is sometimes referred to as signature data or signature dataset of the LiDAR system or the galvanometer mirror. Calibration of internal reflection pattern may be performed at various times during a LiDAR system's product lifecycle. For example, calibration may be performed before the LiDAR system leaves the factory, when the LiDAR system is first installed on a vehicle, when the LiDAR system (or the vehicle) is turned on, or at regular vehicle maintenance, etc. Calibration may also be performed periodically at any given time intervals, e.g., twice a year, once a month, every 7 days, every day, or every two hours, etc. Calibration may be performed automatically by software or manually by a user or technician. In some embodiments, after each calibration, the dataset of the LiDAR system's internal reflection pattern may be stored in a non-volatile memory for later comparison and/or analysis.

Referring still to FIG. 14, dataset 1402 is obtained in the same way as dataset 1401, except that dataset 1402 is obtained at a later time. Dataset 1402 is sometimes referred to as the measurement data or measurement dataset. Dataset 1402 can be captured at various intervals, such as every frame or at other specified intervals. Dataset 1401 represents the last-known internal reflection pattern that is calibrated. It serves as the basis for other internal reflection patterns obtained at runtime (such as dataset 1402) to compare with. When the zero-angle position of the galvanometer mirror has not shifted, the internal reflection pattern measured at runtime, e.g., dataset 1402, should match well with dataset 1401. However, if the two datasets do not fit well (as shown in FIG. 14), it indicates that the zero-angle position of the galvanometer mirror may have shifted. Therefore, the difference between the two datasets may be calculated to determine whether a shift in the zero-angle position of the galvanometer mirror has occurred, and if so, the degree of the shift.

There are several ways to determine whether two datasets fit well with each other. In one embodiment, a Root Mean Square Error (RMSE) method can be used to calculate the difference between dataset 1401 (dataset A) and dataset 1402 (dataset B) according to the following formula (3):

$$R MSE = \sqrt{\frac{1}{n} {\sum }_{i = 1}^{n} {( {A}_{i} - {B}_{i} )}^{2}} \qquad ( 3 )$$

where n represents the number of data points in datasets A and B, Aᵢ represents the value for the i^{th} data point in dataset A, and Bᵢ represents the value for the i^{th} data point in dataset B.

In another embodiment, a Sum of Squared Difference (SSD) method can be used to calculate the difference between dataset 1401 (dataset A) and dataset 1402 (dataset B) according to the following formula (4):

$$S S D = {\sum }_{i = 1}^{n} {( {A}_{i} - {B}_{i} )}^{2} \qquad ( 4 )$$

where n represents the number of data points in datasets A and B, Aᵢ represents the value for the i^{th} data point in dataset A, and Bᵢ represents the value for the i^{th} data point in dataset B. In other embodiments, other methods for calculating the difference between two datasets may also be used.

After the differences between datasets 1401 and 1402 are calculated, in some embodiments, if the differences between the two datasets exceed a threshold, the LiDAR system determines that the zero-angle position of the galvanometer mirror has shifted. In some embodiments, the LiDAR system may inform the vehicle control system and/or the user regarding the shift of the zero-angle position. Otherwise, if the calculated difference does not exceed the threshold, the LiDAR system determines that the zero-angle position of the galvanometer mirror has not shifted. In some embodiments, if it is determined that a shift of zero-angle position has occurred, a Sum of Squared Difference chart may be calculated to further determine the degree of the shift.

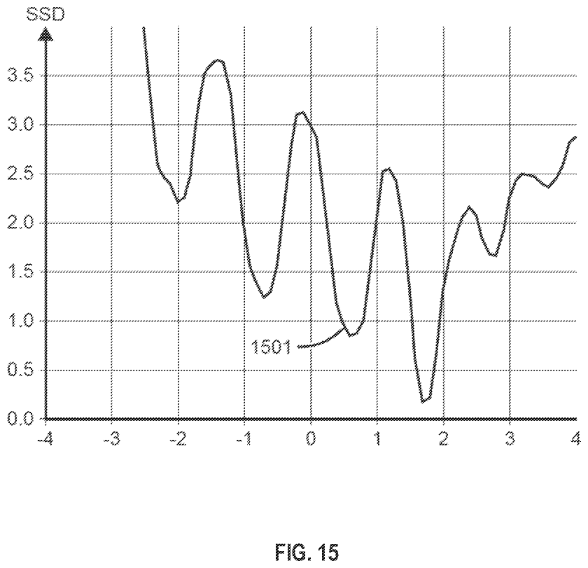

FIG. 15 illustrates a Sum of Squared Difference chart of a galvanometer mirror which zero-angle position has shifted according to one embodiment. The horizontal coordinate represents the degrees to which dataset 1402 is being shifted in FIG. 13. The vertical coordinate represents the SSD between datasets 1402 and 1401 calculated corresponding to each degree in which dataset 1402 is being shifted. To draw the SSD curve 1501 in FIG. 15 based on dataset 1402 in FIG. 14, dataset 1402 is shifted in FIG. 14 left and right to a certain degrees, e.g., 0.1 degree incrementally between −4° and +4°. Then, at each shifted position of dataset 1402, an SSD between datasets 1402 and 1401 is calculated and plotted on FIG. 15. After the entire SSD curve 1501 is calculated and plotted, the degree where dataset 1402 fits the best with dataset 1401 can be found at the lowest point of curve 1501.

If the galvanometer mirror has not shifted, the lowest point on curve 1501 should occur at or close to 0 degrees. In the example depicted in FIG. 15, the lowest point on curve 1501 occurs at approximately +1.8°, indicating a shift of approximately +1.8° in the galvanometer mirror's zero-angle position.

In one embodiment, shifting dataset 1402 left or right a certain degrees is realized by moving data points in dataset 1402 left or right by a certain number of positions. The number of positions being moved corresponds to the degrees being shifted. The direction of the move (left or right) corresponds to the plus or minus sign of the degrees being shifted.

In one embodiment, the determination of whether the zero-angle position of the galvanometer mirror has been shifted is based on the degree corresponding to the lowest point of curve 1501. If the lowest point of curve 1501 occurs at 0 degree, or within a certain threshold, the LiDAR system will determine that the zero-angle position of the galvanometer mirror has not shifted. If the lowest point of curve 1501 occurs at a degree beyond the threshold, the LiDAR system will determine that the zero-angle position of the galvanometer mirror has shifted. This may trigger a series of actions of the LiDAR system. For example, the LiDAR system may flag errors or warnings to the user or the control system, or record the errors or warnings in a non-volatile memory.

In some embodiments, if the degrees to which the galvanometer mirror has shifted has exceeded a maximum allowable limit, e.g., ±5°, the LiDAR system may determine that the galvanometer mirror has failed. In case of a catastrophic failure of the galvanometer mirror during the LiDAR system's operation, the control circuitry may realize the failure after a long time (many frames). With the methods disclosed herein, the control circuitry can know the failure instantly within one frame. In some embodiments, if the shift has not exceeded the limit, the control circuity of the LiDAR system or the vehicle perception and control system may use software to compensate the shift.

In some embodiments, small patches of higher reflectivity may be manually introduced to the components or windows of the LiDAR system housing to create stronger scatter pulses in known areas. Thes small patches may be arranged in unique patterns. By adding small reflective patches, the internal reflection pattern of a LiDAR system can be manually adjusted to make it more distinct from other LiDAR systems. Additionally, the curves of datasets shown in FIG. 14 can be adjusted to make the two curves easier to fit. In some embodiments, known markers may be added to the windows of the LiDAR system housing. These markers generate predictable scatter pulses at corresponding angular positions of the galvanometer mirror. By comparing the differences between the measured scattered pulses and the expected scatter pulses reflected from these markers, galvanometer mirror calibration may be performed at any time, without user interference.

In some embodiments, datasets 1401 and 1402 do not span the entire vertical range of the FOV and only contain a subset of the entire range. For example, the datasets (both the calibration dataset 1401 and the runtime dataset 1402) only contain data points corresponding to scan lines in the center region of the FOV, for example, between −5° and 5° of the vertical FOV. In this way, fewer calculations are required to compare the two datasets, resulting in faster and more efficient determination of the shift of the galvanometer mirror.

In some embodiments, light source 310 may have multiple laser channels with multiple laser emitters, which generate multiple outgoing light pulses simultaneously. The internal reflection patterns of different channels may be different, at least because the multiple outgoing light pulses are transmitted at a slightly different angle with one another within the LiDAR system housing. In the case of multiple laser channels, one runtime internal reflection pattern (e.g., dataset 1402) per each channel is calculated. However, SSD curve 1501 is plotted by combining the SSD values for all the channels at each corresponding degree in the SSD chart. In another embodiment, SSD curve 1501 is plotted per each channel, and the determination of the shift of the galvanometer mirror is made individually per each channel. Ideally, the determinations of all the channels should be the same. If not, another measurement may be performed. If the inconsistency continues, the majority of the determination by all the channels may be chosen as the final determination of the LiDAR system.

In some embodiments, datasets (or internal reflection patterns) in FIG. 14 can be in a three-dimensional space. This is because the intensity map of FIG. 13 is three-dimensional. Each point in the intensity map has a two-dimensional position in frame 1300. The value of the point (the scattered pulse intensity) represents the third dimension. Therefore, instead of using a curve (1401 or 1402) in FIG. 14 to represent a 2D signature pattern of a LiDAR system, a 3D curved surface can be used to represent a 3D signature pattern of the LiDAR system. In these embodiments, the differences between a calibrated 3D dataset (equivalent to dataset 1401 in a 2D space) and a runtime 3D dataset (equivalent to dataset 1402 in a 2D space) can be calculated point-by-point. The methods disclosed previously for calculating the differences between the two 2D datasets can be adapted to the three-dimensional space.

FIG. 16 is a flowchart illustrating a method for tracking zero-angle position shift of a moveable mirror used in a LiDAR system according to one embodiment. Method 1600 may be performed by LiDAR system 300 and control circuitry 350 in FIG. 3.

Method 1600 includes step 1610, in which a LiDAR system obtains a first dataset based on a first intensity map, wherein the first intensity map is associated with internal reflection pulses of a frame scanned by the LiDAR system, the frame comprising a plurality of scan positions, the internal reflection pulses being formed by scattering or reflecting one or more transmission light pulses at positions internal to a housing of the LiDAR system, and wherein the first dataset is a calibration dataset comprising representative intensity values and corresponding positions in the frame.

An intensity map is associated with a frame scanned by the LiDAR system. For example, in one embodiment, a frame such as frame 1300 of FIG. 13 has N horizontal scan lines. Each horizontal scan line has M scan positions (points). Each point in frame 1300 corresponds to a coordinate in the FOV, which corresponds to a transmission light pulse transmitted on that position. When the transmission light pulse passes through a window of the LiDAR system housing at a certain angle, a small portion of it is reflected back as an internal reflection pulse toward the inside of the housing. The internal reflection pulse may be reflected by the internal components of the housing several times, and may eventually be detected by a light detector of the LiDAR system. The intensity of the internal reflection pulse can be determined when detected. In one embodiment, the first intensity map comprises intensity values of the internal reflection pulses received at each particular scan position.

The first dataset is obtained based on the intensity map associated with a frame. In one embodiment, the first dataset comprises a set of N data points. Each data point of the dataset can be obtained by calculating the average intensity (the representative intensity) for each of the N scan lines in frame 1300. In some embodiments, the average intensity can be calculated based on a group of selected points in the corresponding scan line. The first dataset is obtained when the LiDAR system's internal reflection pattern is being calibrated. In some embodiments, calibration may be performed automatically by software or manually by a user or technician.

Method 1600 further includes step 1620, in which the LiDAR system obtains a second intensity map of another frame at a subsequent time and obtaining a second dataset based on the second intensity map. In this step, the second dataset is obtained in the same way as the first dataset, except that second dataset is obtained at a later time. The second intensity map is also similar to the first intensity map, except that it is obtained from another frame at a later time.

Method 1600 further includes step 1630, in which the LiDAR system determines the zero-angle position shift of the moveable mirror based on the first dataset and the second dataset. In this step, the differences between the first dataset and the second dataset are calculated to see if the two datasets fit well. If the two datasets do not fit well, it indicates that the zero-angle position of the galvanometer mirror may have shifted.

There are several ways to determine whether two datasets fit well with each other. In some embodiments, a Root Mean Square Error (RMSE) method or a Sum of Squared Difference (SSD) method may be used. After the differences between the two datasets are calculated, in some embodiments, if the differences exceed a threshold, the LiDAR system determines that the zero-angle position of the galvanometer mirror has shifted. Otherwise, the LiDAR system determines that the zero-angle position of the galvanometer mirror has not shifted.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method for tracking zero-angle position shift of a moveable mirror used in a light detection and ranging (LiDAR) system, the method comprising:
obtaining a first dataset based on a first intensity map,
wherein the first intensity map is associated with internal reflection pulses of a frame scanned by the LiDAR system, the frame comprising a plurality of scan positions, the internal reflection pulses being formed by scattering or reflecting one or more transmission light pulses at positions internal to a housing of the LiDAR system, and
wherein the first dataset is a calibration dataset comprising representative intensity values and corresponding positions in the frame;
obtaining a second intensity map of another frame at a subsequent time and obtaining a second dataset based on the second intensity map; and
determining the zero-angle position shift of the moveable mirror based on the first dataset and the second dataset.

2. The method of claim 1, wherein the first intensity map comprises intensity values of the internal reflection pulses received at the plurality of scan positions.

3. The method of claim 2, wherein the intensity values of the internal reflection pulses are obtained by:
directing, by the moveable mirror, the one or more transmission light pulses for scanning a field-of-view external to the LiDAR system;
receiving the internal reflection pulses by a receiver of the LiDAR system, wherein the internal reflection pulses correspond to respective transmission light pulses; and
determining, by the LiDAR system, intensity values of the internal reflection pulses.

4. The method of claim 1, wherein the frame is scanned in a first direction and a second direction, the first direction corresponding to movement positions of the moveable mirror, the second direction corresponding to movement positions of a second mirror of the LiDAR system.

5. The method of claim 4, wherein the corresponding positions in the frame are corresponding positions in the first direction of the frame.

6. The method of claim 4, wherein the representative intensity values comprise average intensity values of internal reflection pulses received at scan positions in the second direction associated with the corresponding positions in the first direction of the frame.

7. The method of claim 4, wherein the first direction is a vertical direction, and the second direction is a horizontal direction.

8. The method of claim 4, wherein the first direction is a horizontal direction, and the second direction is a vertical direction.

9. The method of claim 4, wherein the representative intensity values are calculated based on average intensity values of internal reflection pulses received at selected scan positions near the center of scan lines associated with the corresponding positions in the first direction of the frame.

10. The method of claim 1, wherein the moveable mirror is an oscillation mirror configured to oscillate between two end angular positions, and wherein the movement positions of the moveable mirror are angular positions of the oscillation mirror.

11. The method of claim 1, wherein the first dataset is calibrated at periodical intervals or at one or more of: before the LiDAR system leaves factory, when the LiDAR system is first installed on a vehicle, and during regular maintenance of the vehicle.

12. The method of claim 1, wherein the positions internal to the housing of the LiDAR system comprise positions associated with a window of the LiDAR system.

13. The method of claim 1, wherein the positions internal to the housing of the LiDAR system comprise positions at one or more of a polygon mirror, a lens, an optical or electrical component inside the housing of the LiDAR system, and an inner surface of the housing.

14. The method of claim 1, wherein determining the zero-angle position shift of the moveable mirror based on the first dataset and the second dataset comprises:
calculating a value of difference between the first dataset and the second dataset;
determining the zero-angle position shift of the moveable mirror based on the calculated value of difference and a threshold.

15. The method of claim 14, wherein the value of difference between the first dataset and the second dataset is calculated based on one of a Root Mean Square Error (RMSE) method and a Sum of Squared Difference (SSD) method.

16. The method of claim 1, wherein determining the zero-angle position shift of the moveable mirror based on the first dataset and the second dataset comprises:
(a) obtaining a shifted second dataset by moving data points in the second dataset by one or more positions to left or right directions;
(b) calculating a value of difference between the first dataset and the shifted second dataset;
repeating steps (a) and (b) for multiple times to obtain a series of values of differences; and
determining the zero-angle position shift of the moveable mirror based on the lowest value of difference in the series of values of differences.

17. The method of claim 16, wherein the value of difference between the first dataset and the shifted second dataset is calculated based on one of a Root Mean Square Error (RMSE) method and a Sum of Squared Difference (SSD) method.

18. The method of claim 16, wherein the LiDAR system comprises a plurality of laser channels, and wherein the series of values of differences are obtained by adding the value of difference calculated for each of the plurality of laser channels.

19. The method of claim 1, further comprising:
obtaining a third intensity map of another frame at a subsequent time and obtaining a third dataset based on the third intensity map; and
determining the zero-angle position shift of the moveable mirror based on the first dataset and the third dataset.

20. The method of claim 1, wherein the internal reflection pulses comprise a first internal return light pulse formed by scattering or reflecting a first transmission light pulse of the one or more transmission light pulses, the first internal reflection pulse being received before receiving an object-returned light pulse formed by scattering or reflecting the first transmission light pulse at positions external to the housing of the LiDAR system.

21. The method of claim 1, further comprising:
triggering an action of the LiDAR system or a device associated with the LiDAR system based on the determined zero-angle position shift of the moveable mirror and a threshold.

22. The method of claim 21, wherein the triggering of an action of the LiDAR system comprises one or more of:
recording an indication of the zero-angle position shift;
providing an alert;
pausing or stopping operation of the moveable mirror; and
pausing or stopping operation of the LiDAR system.

23. The method of claim 1, wherein the first intensity map is associated with internal reflection pulses of multiple frames scanned by the LiDAR system.

24. A LiDAR system for tracking zero-angle position shift of a moveable mirror of the LiDAR system, comprising:
one or more processors,
a memory device, and
processor-executable instructions stored in the memory device, the processor-executable instructions comprising instructions for:
obtaining a first dataset based on a first intensity map,
wherein the first intensity map is associated with internal reflection pulses of a frame scanned by the LiDAR system, the frame comprising a plurality of scan positions, the internal reflection pulses being formed by scattering or reflecting one or more transmission light pulses at positions internal to a housing of the LiDAR system, and
wherein the first dataset is a calibration dataset comprising representative intensity values and corresponding positions in the frame;
obtaining a second intensity map of another frame at a subsequent time and obtaining a second dataset based on the second intensity map; and
determining the zero-angle position shift of the moveable mirror based on the first dataset and the second dataset.

25. The LiDAR system of claim 24, wherein the first intensity map comprises intensity values of the internal reflection pulses received at the plurality of scan positions.

26. The LiDAR system of claim 24, wherein the frame is scanned in a first direction and a second direction, the first direction corresponding to movement positions of the moveable mirror, the second direction corresponding to movement positions of a second mirror of the LiDAR system.
